(19) United States
(12) Patent Application Publication
(10) Pub. No.: US 2009/0135128 A1
(43) Pub. Date: May 28, 2009

(54) BACKLIGHT UNIT ASSEMBLY AND LIQUID CRYSTAL DISPLAY HAVING THE SAME

(76) Inventors: Eun-Chae JEON, Seoul (KR); Si-Joon Song, Suwon-si (KR); Jeom-Oh Kim, Buan-gun (KR)

Correspondence Address: Haynes and Boone, LLP;IP Section, 2323 Victory Avenue, SUITE 700, Dallas, TX, 75219, US

(21) Appl. No.: 12/276,018

(22) Filed: Nov. 21, 2008

(30) Foreign Application Priority Data
Nov. 23, 2007 (KR) 10-2007-0120196

(51) Int. Cl. G09G 3/36

(52) U.S. Cl. 345/102

(57) ABSTRACT

In accordance with embodiments of the present disclosure, a backlight unit assembly is provided with a lamp and a light emitting diode (LED) periodically turned on and off, and a liquid crystal display having the backlight unit assembly. A light source is configured with both the lamp and the LED, and the LED is periodically turned on and off by applying a start signal, which are capable of removing image sticking on a liquid crystal display (LCD) panel. This feature may reduce power consumption and increase contrast ratio. The backlight unit assembly and the LCD are capable of adjusting a chromaticity coordinate of the light source to a reference chromaticity coordinate.

### CROSS-REFERENCE TO RELATED APPLICATIONS

This application claims priority to and the benefit of Korean Patent Application No. 10-2007-0120196, filed on Nov. 23, 2007, in the Korean Intellectual Property Office, the disclosure of which is incorporated herein by reference in its entirety.

### BACKGROUND

1. Technical Field

The present disclosure relates to a backlight unit assembly and a liquid crystal display (LCD) having the same, and more particularly, to a backlight unit assembly having a lamp and a light emitting diode (LED) periodically turned on and off, and an LCD having the backlight unit.

2. Description of Related Art

In general, liquid crystal displays (LCD) are being increasingly utilized due to a wide application area and advantageous characteristics, such as lightness, slimness, low power performance, full-color, and high definition. Presently, LCDs are being utilized in computers, notebooks, personal digital assistants (PDAs), telephones, televisions, and various types of audio/video devices.

The LCD displays an image on an LCD panel by controlling light transmittance based on an image signal applied to a plurality of control switches arranged in a matrix form. The LCD is a passive device, which does not emit light, and thus usually needs a light source, such as a backlight. Some examples of light sources include, a point light source (e.g., a light emitting diode (LED)) a line light source (e.g., an electroluminescent lamp (EL)) and a cold cathode fluorescent lamp (CCFL).

Recently, attempts are being made to use the LED (e.g., a point light source) as a light source for the backlight unit of the LCD. The LED has several advantages, such as low power consumption and fast response speed in comparison with a typical lamp source. However, a plurality of LEDs are necessary for using the LED as a light source for the backlight unit. Accordingly, although the LED is better in performance to a lamp, a unit price of the LED is considerably higher than that of the lamp, which may lead to difficulties for mass production due to high fabrication costs.

### SUMMARY

The present disclosure provides a backlight unit assembly with LEDs and low fabrication cost, and a liquid crystal display (LCD) having the backlight unit assembly.

In accordance with an exemplary embodiment, a backlight unit assembly includes: a light source having a lamp and a light emitting diode (LED); and a backlight unit driver having a lamp driving unit configured to drive the lamp and an LED driving unit configured to periodically turn on and off the LED.

The lamp and the LED may emit respective white colors of which chromaticity coordinates are different from each other. The LED driving unit may include a flash signal generator configured to generate a flash signal synchronized with a frame of an image signal. The backlight unit assembly may include a controller configured to control the backlight unit driver, wherein the flash signal generator is driven by a start signal applied once from the controller.

The LED driving unit may include: a modulator configured to modulate an LED driving signal including the flash signal applied from the flash signal generator; and an LED driver configured to stably apply the LED driving signal applied from the modulator to the LED. The modulator may change a pulse width of a pulse signal generated by the flash signal to be narrowed for adjusting brightness of the LED.

The backlight unit driver may include a chromaticity coordinate comparator configured to adjust a chromaticity coordinate of the light source. The chromaticity coordinate comparator may include: a light receiver configured to measure a chromaticity coordinate of the light source; and a comparator configured to correct a chromaticity coordinate of the light source depending on the chromaticity coordinate of the light source measured by the light receiver. The chromaticity coordinate comparator may include a memory configured to store matching data, which is a chromaticity coordinate correction value of the light source, and the comparator may compare the measured chromaticity coordinate of the light source with the matching data to apply a chromaticity coordinate correction value to the controller.

The controller may include: a brightness controller configured to generate a brightness control signal for adjusting brightness of the LED depending on an image signal applied from an external source; and a dimming controller configured to generate a dimming control signal, which adjusts brightness of the LED depending on the brightness control signal applied from the brightness controller, and to apply the dimming control signal to the flash signal generator.

In accordance with another exemplary embodiment, a liquid crystal display (LCD) includes: an LCD panel configured to display an image; an LCD panel driver configured to drive the LCD panel; a backlight unit configured to provide light to the LCD panel, the backlight unit including a light source having a lamp and an LED; and a backlight unit driver having a lamp driving unit configured to drive the lamp and an LED driving unit configured to periodically turn on and off the LED.

The LED driving unit may include a flash signal generator configured to generate a flash signal for turning on and off the LED. In one implementation, the flash signal generator may be driven by a smart signal applied once.

The backlight unit driver may include a chromaticity coordinate comparator configured to adjust a chromaticity coordinate of the light source. The chromaticity coordinate comparator may include: a memory configured to store matching data, which is a chromaticity coordinate correction value of the light source; a light receiver configured to measure a chromaticity coordinate of the light source; and a comparator configured to compare the measured chromaticity coordinate of the light source with the matching data to apply a chromaticity coordinate correction value to a controller.

The LCD panel may include at least one or more LCD panel block regions, and the backlight unit may include an LED block region that corresponds to the LCD panel block region and has at least one or more LEDs. In one implementation, the LCD may include: a brightness controller configured to determine an average brightness of the LCD panel block regions depending on an image signal applied from an external source to generate a brightness control signal containing the average brightness; and a dimming controller configured to generate a dimming control signal for separately adjusting brightness of the LED block region according to the brightness control signal applied from the brightness controller, and to apply the dimming control signal to the flash signal generator.

In accordance with yet another exemplary embodiment, a liquid crystal display (LCD) includes: an LCD panel configured to display an image; an LCD panel driver configured to drive the LCD panel; a backlight unit configured to provide light to the LCD panel, the backlight unit including a light source having a lamp and an LED; and a backlight unit driver having a lamp driving unit and an LED driving unit that are respectively operated at different frequencies.

The LCD may include a controller. In one implementation, the controller may include: a field-programmable gate array (FPGA) configured to code/decode an image signal applied from an external source; and a time controller configured to apply frame information of an image signal applied from the FPGA to a flash signal generator. The time controller may include a control signal generator configured to multiplicatively increase a frame rate. The LED may include a red LED, a green LED and a blue LED, and the time controller may divide one frame into a plurality of sub frames. The red, green and blue LEDs emit light in three sub frames of the plurality of sub frames. The three sub frames may include a red data signal, a green data signal and a blue data signal, and the red, green and blue LEDs may emit light corresponding to colors of the three sub frames, respectively.

### BRIEF DESCRIPTION OF THE DRAWINGS

Exemplary embodiments will be understood in more detail from the following description taken in conjunction with the accompanying drawings, in which:

FIG. 1 is a schematic exploded perspective view of a backlight unit assembly, in accordance with an exemplary embodiment;

FIG. 2 is a schematic cross-sectional view taken along line A-A of FIG. 1;

FIG. 3 is a schematic plan view of the backlight unit assembly, in accordance with the exemplary embodiment of FIG. 1;

FIG. 4 is a concept view of the backlight unit assembly, in accordance with the exemplary embodiment of FIG. 1;

FIG. 5 is a waveform diagram illustrating waveforms of signals of a light emitting diode (LED) driving unit in the backlight unit assembly of FIG. 1;

FIG. 6 is a schematic exploded perspective view of a backlight unit assembly, in accordance with another exemplary embodiment;

FIG. 7 is a schematic cross-sectional view taken along line B-B of FIG. 6;

FIG. 8 is a concept view of a backlight unit assembly, in accordance with still another exemplary embodiment;

FIG. 9 is a concept view of a backlight unit assembly, in accordance with even another exemplary embodiment;

FIG. 10 is a schematic exploded perspective view of a liquid crystal display (LCD), in accordance with an exemplary embodiment;

FIG. 11 is a schematic cross-sectional view taken along line C-C of FIG. 10;

FIG. 12 is a concept view of the LCD, in accordance with the exemplary embodiment of FIG. 10;

FIG. 13 is a schematic exploded perspective view of an LCD, in accordance with another exemplary embodiment;

FIG. 14 is a waveform diagram illustrating waveforms of driving signals in the LCD, in accordance with the exemplary embodiment of FIG. 13; and

FIG. 15 is a concept view of an LCD, in accordance with still another exemplary embodiment.

### DETAILED DESCRIPTION OF EMBODIMENTS

Hereinafter, specific embodiments will be described in detail with reference to the accompanying drawings. The present disclosure may, however, be embodied in different forms and should not be construed as being limited to the embodiments set forth herein. Rather, these embodiments are provided so that this disclosure will be thorough and complete, and will fully convey the scope of the present disclosure to those skilled in the art. In the figures, like reference numerals refer to like elements throughout.

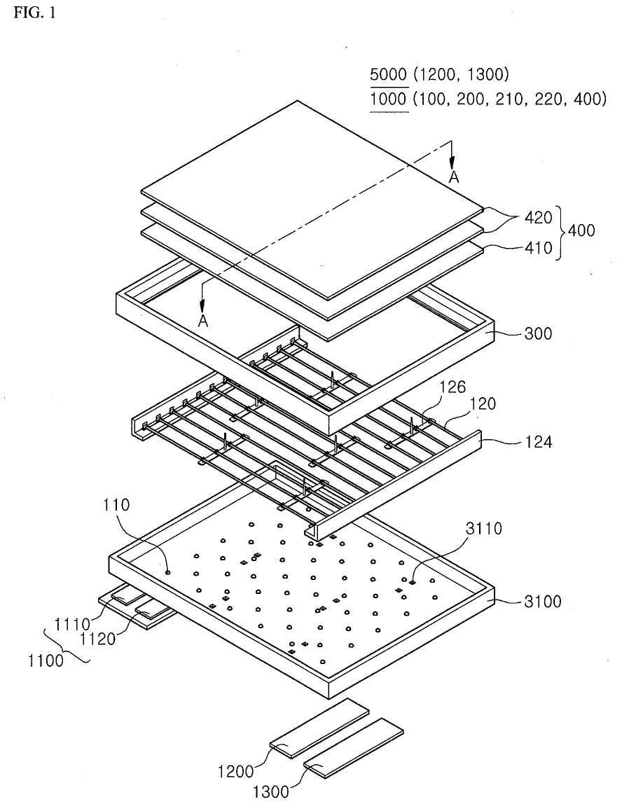

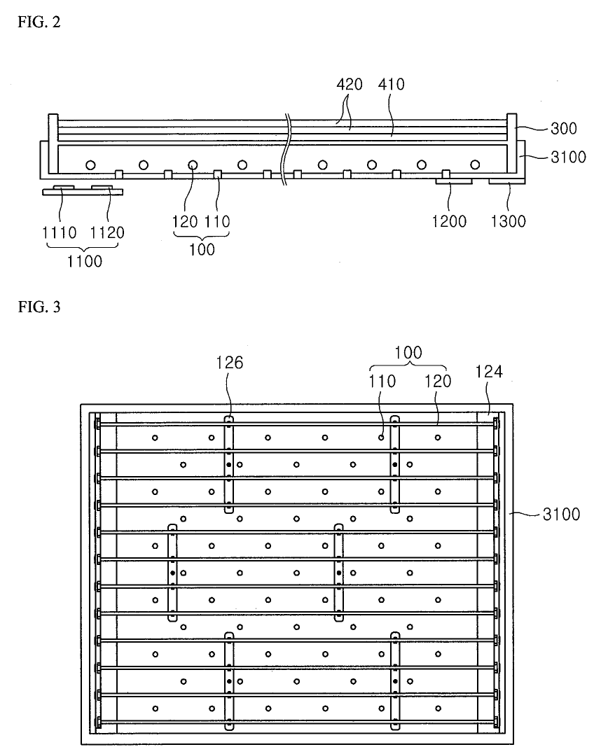

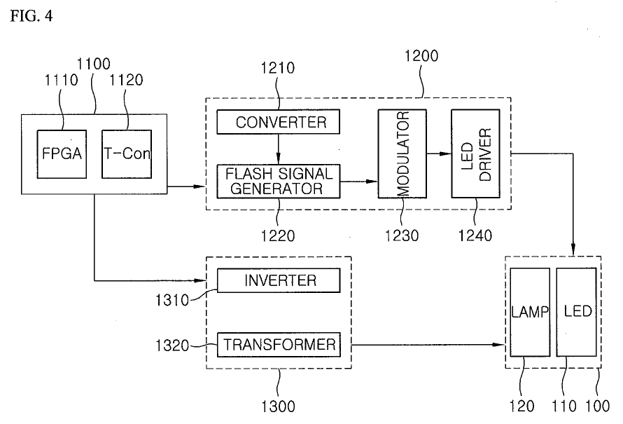

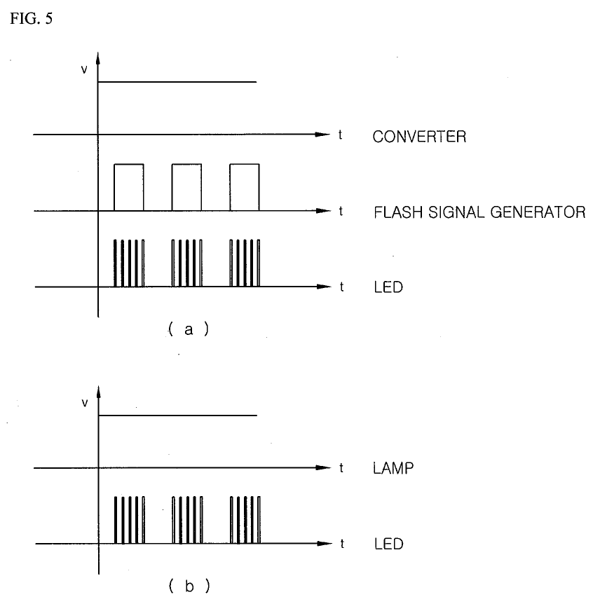

FIG. 1 is a schematic exploded perspective view of a backlight unit assembly, in accordance with an exemplary embodiment. FIG. 2 is a schematic cross-sectional view taken along line A-A of FIG. 1. FIG. 3 is a schematic plan view of the backlight unit assembly in accordance with the exemplary embodiment of FIG. 1. FIG. 4 is a concept view of the backlight unit assembly, in accordance with the exemplary embodiment of FIG. 1. FIG. 5 is a waveform diagram illustrating waveforms of signals of a light emitting diode (LED) driving unit in the backlight unit assembly of FIG. 1.

A backlight unit assembly, in accordance with this exemplary embodiment, includes a backlight unit 1000 having a light source 100 and an optical sheet 400, a backlight unit driver 5000 configured to drive the backlight unit 1000, and a controller 1100 configured to control the backlight unit driver 5000. The backlight unit assembly may include a lower receiving member 3100 configured to receive and protect the backlight unit 1000 and the backlight unit driver 5000.

The backlight unit 1000, in one embodiment, may include the light source 100 configured with lamps 120 and LEDs 110, and the optical sheet 400 configured to improve the quality of light emitted from the light source 100. The backlight unit 1000 may include a lamp fixing unit 124 configured to support the lamp 120 and supply power, and a lamp supporter 126 configured to support the lamp 120 and the optical sheet 400. The lamp fixing unit 124 may include a base plate on which one end of the lamp 120 is placed, and a fixing clip/fixing protrusion protruding from the base plate to fix the lamp 120. The lamp supporter 126 may be fixed such that it is mounted on the lower receiving member 3100. The lamp supporter 126 may have a structure, for example, hooks (not shown), enabling the lamp supporter 126 to be fixed to the lower receiving member 3100. The lower receiving member 3100 may have a plurality of through holes 3110 to which the hooks may be fixed.

In one implementation, a cold cathode fluorescent lamp (CCFL) may be used as the lamp 120. In this instance, each of the lamps 120 includes a glass tube, inert gas contained in the glass tube, and a cathode and an anode disposed on both ends or on one end of the glass tube. An inner wall of the glass tube may be coated with phosphor. The lamps 120 may be arranged at regular intervals for achieving brightness uniformity. The number of the lamps 120 may be determined according to desired brightness.

The LED 110, in one embodiment, may include an LED chip, a base member and an external power input member. The LED chip, which has a stack structure of a compound semiconductor having a p-n junction, emits light by recombination of minor carriers, e.g., electrons or holes. The base member receives the LED chip, and the external power input member applies external power to the LED chip. The LED 110 of this exemplary embodiment may include a blue LED chip configured to provide white color of high color reproduction, a green phosphor converting blue light emitted from the blue LED chip to green light, and a red phosphor converting blue light emitted from the blue LED chip to red light. The green phosphor and the red phosphor may be mixed and coated on the LED chip.

The LED 110 having the above construction emits a portion of blue light emitted from the blue LED chip to the outside through a region where the green phosphor and the red phosphor are not coated. The other portion of the blue light is excited by the green phosphor and the red phosphor so that green light and red light are emitted. The emitted blue light, green light and red light are then mixed together so that white light is emitted to the outside of the LED 110. Accordingly, the LED 110 has blue, green and blue spectra to thereby realize white light of high color reproduction. It should be appreciated that the present disclosure is not limited to the LED having the above construction. That is, various LEDs, for example, an LED using yellow phosphor applied to a blue LED chip, may be employed besides the above-described LED.

In the backlight unit, in accordance with this exemplary embodiment, the lamp 120 and the LED 110 may be provided in plurality, and the LEDs 110 may be disposed between the lamps 120 arranged at regular intervals. In this exemplary embodiment, the LEDs 110 are mounted on the lower receiving member 3100 such that they penetrate the lower receiving member 3100.

The optical sheet 400, in one embodiment, is used for making bright distribution of light emitted from the light source 100 uniform and improving light quality. The optical sheet 400 may include a diffusion sheet 410 and a prism sheet 420. The diffusion sheet 410 directs the light received from the light source 100 disposed thereunder toward the front of an LCD panel (not shown), and diffuses light to have uniform distribution over a wide range so that the light with uniform distribution is irradiated onto the LCD panel. The prism sheet 420 changes an optical path to thereby vertically emit light, which is slantly incident thereon.

In one embodiment, the backlight unit driver 5000 for driving the light source 100 includes a lamp driving unit 1300 configured to drive the lamps 120, and an LED driving unit 1200 configured to drive the LEDs 110. The lamp driving unit 1300, which is used to drive the lamps 120, may include a transformer 1320 and an inverter 1310 configured to convert an external power to be suitable for driving the lamps 120. The transformer 1320 boosts an alternate current (AC) power inputted from the outside to be adapted to drive the lamps 120, and thereafter applies the boosted AC power. The transformer 1320 continuously applies the AC power to the lamps 120 when the backlight unit assembly is operating, thus turning on the lamps 120.

The transformer 1320 is used to receive AC power converted by the inverter 1310 to change the magnitude of the AC power to be suitable for driving the lamps 120 and to supply the AC power with the changed magnitude to the lamps 120. Specifically, the transformer 1320 adjusts the magnitude of power outputted to an internal coil. The lamp driving unit 1300 may include a socket board (not shown) between the transformer 1320 and the lamp 120. The socket board is used to apply the power supplied from the transformer 1320 to the lamp 120. The socket board may be disposed in a lower portion of the lower receiving member 3100, and may be connected to the lamp through an interconnection (not shown).

In one embodiment, the LED driving unit 1200, which is used to drive the LEDs 110, may include a converter 1210 configured to convert a power to be supplied to the LED 110 into a direct current (DC) power, a flash signal generator 1220 configured to generate a flash signal for turning on and off the LEDs 110, a modulator 1230 configured to modulate a signal applied from the flash signal generator 1220, and an LED driver 1240 configured to apply a signal applied from the modulator 1230 to the LEDs 110. The converter 1210, which is used to convert an external power to a power adapted to drive the LEDs 110, converts an external AC power to a DC power adapted to drive the LEDs 110 in this exemplary embodiment.

In one embodiment, the flash signal generator 1220, which is used to generate the flash signal to be applied to the LEDs 110, periodically turns on and off the DC power converted at the converter 1210, thus enabling the LEDs 110 to be periodically turned on and off. For example, as shown in FIG. 5(a), it is possible to convert the DC power of the converter 1210 into an LED driving signal, e.g., a pulse wave, which enables the LEDs 110 to be turned on and off. The pulse wave has a pulse width to periodically turn on and off the LEDs 110. The signal generated from the flash signal generator 1220 may enable the LEDs 110 to be turned on and off through a start signal applied once from the controller 1100. As such, the signal generated from the flash signal generator 1220 may be controlled such that a duty ratio (e.g., ratio of ON-time to OFF-time) of the pulse wave corresponds to a frame of the LCD panel. That is, the duty ratio is appropriately controlled so as to turn off the LEDs 110 between frames of an image displayed on the LCD panel and to turn on the LEDs 110 while the frame is displayed, thus making a user not recognize image sticking between the frames.

In one embodiment, the modulator 1230, which is used to adjust brightness of the LED 110, includes a pulse width modulator. The modulator 1230 modulates the signal applied from the flash signal generator 1220, for example, the pulse wave, to supply the modulated signal to the LEDs 110. The modulator 1230 modulates the signal applied from the flash signal generator 1220 in pulse-width modulation (PWM) manner such that a pulse width of the signal is narrowed according to the magnitude of a modulation signal, as shown in FIG. 5(a). Through the PWM, the duty ratio of the pulse wave, which is periodically turned on and off, is changed to thereby adjust the brightness of the LED 110.

In one embodiment, the LED driver 1240, which is used to apply the signal applied from the modulator 1230 to the LEDs 110, may drive the LEDs 110 to be operated with stable brightness and high efficiency even if an input voltage severely fluctuates or is very low. The LED driver 1240 may be configured in the shape of an integrated circuit (IC). The LED driver 1240 may be provided in plurality depending on number of the LEDs 110. The controller 1100, which is used to control the backlight unit driver 5000, may include a field-programmable gate array (FPGA) 1110 and a time controller 1120. The FPGA 1110, which is used to code/decode an image signal, codes and decodes an image signal applied from the outside to apply the coded/decoded image signal to the time controller 1120. The FPGA 1110 applies the image signal to an LCD panel driver (not shown) to be later described, as well as to the time controller 1120.

The time controller 1120, in one embodiment, is used to apply frame information of the image signal applied from the FPGA 1110 to backlight unit driver 5000. The FPGA 1110 and the time controller 1120 may be mounted on a substrate in the shape of an integrated circuit (IC). The time controller 1120 may control a timing of the image signal applied to source and gate drivers of an LCD panel driver (not shown), which is described in greater detail herein.

Although this exemplary embodiment illustrates that the FPGA 1110 and the time controller 1120 are separately provided, the present disclosure is not limited thereto. Hence, the time controller 1120 may be built in the FPGA 1110. Also, although the exemplary embodiment illustrates that the controller 1100 is included in the backlight unit assembly, the present disclosure is not limited thereto. That is, the controller 1110 may be included in an LCD panel driver to be later described.

In the backlight unit assembly having the above-described configuration in accordance with this exemplary embodiment, the lamp driving unit 1300 is controlled by the controller 1100 such that the lamp 120 is turned on. At the same time, when the lamp 120 is turned on, the LED 110 is periodically turned on and off. That is, the lamp 120 and the LED 110 operate at different frequencies, and therefore the lamp driving unit 1300 and the LED driver 1240 apply the different frequencies to the lamp 120 and the LED 110, respectively.

As for operation of the LED 110, the FPGA 1110 applies an image signal applied from the outside to the time controller 1120 first. Thereafter, the time controller 1120 extracts frame information of the image signal, and then applies the extracted frame information to the flash signal generator 1220. The flash signal generator 1220 generates the flash signal by the frame information applied thereto, so that the DC power supplied to the flash signal generator 1220 from the converter 1210 is changed into a pulse signal that is periodically turned on and off. The modulator 1230 changes a duty ratio of the converted pulse signal in PWM manner so as to adjust the brightness of the LED 110, and then applies the pulse signal with the changed duty ratio to the LED driver 1240. The LED driver 1240 stably drives the LED 110 to be tuned on and off according to the signal applied thereto.

In this way, when the backlight unit assembly operates, in accordance with this exemplary embodiment, signals having waveforms shown in FIG. 5(b) are inputted to the lamp 120 and the LED 110, respectively. Therefore, at the same time, when the lamp 120 is turned on, the LED 110 is periodically turned on and off, which makes it possible to remove image sticking on the LCD panel.

Herein below, a backlight unit assembly, in accordance with another exemplary embodiment, will be described with reference to the accompanying drawings. Duplicate description, which has been made in the backlight unit assembly of the previous exemplary embodiment, will be omitted or briefly set forth in a below-described exemplary embodiment.

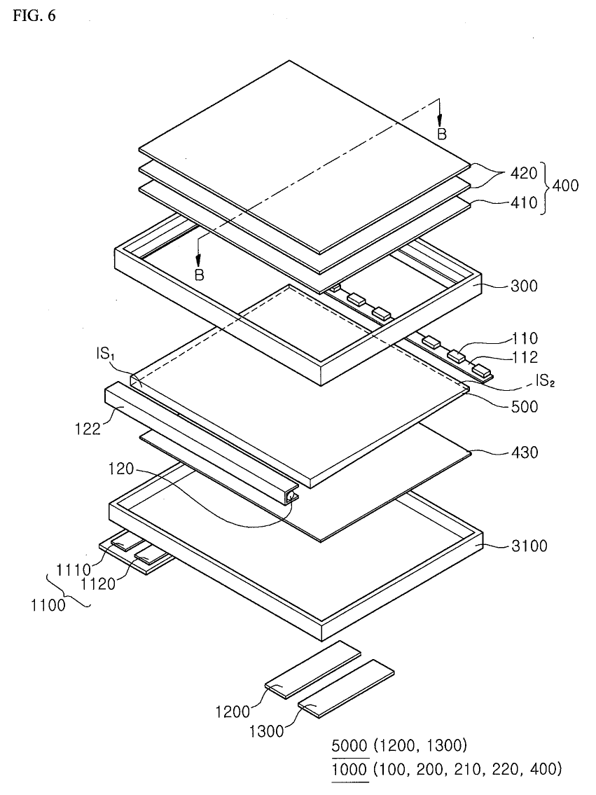

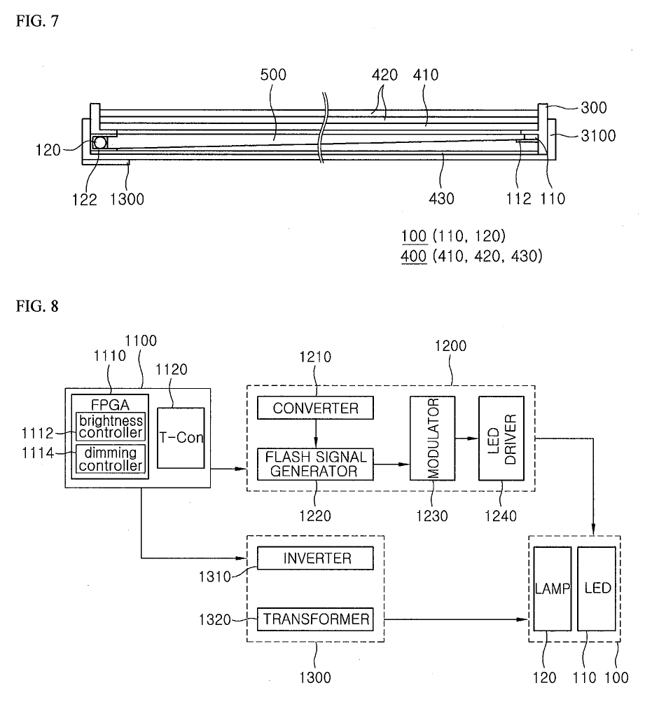

FIG. 6 is a schematic exploded perspective view of a backlight unit assembly in accordance with another exemplary embodiment. FIG. 7 is a schematic cross-sectional view taken along line B-B of FIG. 6.

Referring to FIGS. 6 and 7, the backlight unit assembly of this exemplary embodiment includes a backlight unit 1000 having a light source 100, a light guide plate 500 and an optical sheet 400, a backlight unit driver 5000 configured to drive the backlight unit 1000, and a controller 1100 configured to control the backlight unit driver 5000. The backlight unit 1000 includes the light source 100 that is configured with lamps 120 and LEDs 110 to generate light, and the optical sheet 400 and the light guide plate 500 configured to convert the light emitted from the light source 100 to improve light quality. The light guide plate 500 is used to convert line light from the lamp 120 and point light from the LED 110 into surface light. The light guide plate 500 may be formed of a transparent material having predetermined refractive index, for example, poly methyl methacrylate (PMMA) that is one kind of acryl resin, polyolefin, or polycarbonate. The light emitted from the lamp 120 and the LED 110 is provided through a side of the light guide plate 500, and then emitted upwardly. To simplify the description, the following exemplary embodiment will focus on a rectangular light guide plate with a predetermined thickness.

In the backlight unit 1000, in accordance with this exemplary embodiment, the lamp 120 may be disposed at one side of the light guide plate 500, e.g., a first incident surface IS1, and the LED 110 may be disposed at the other side, e.g., a second incident surface IS2, which faces the first incident surface IS1. To this end, the first incident surface IS1 and the second incident surface IS2 of the light guide plate 500 may have different widths from each other. That is, the first incident surface IS1 where the lamp 120 is positioned may correspond to the width of the lamp 120, and the second plane IS2 where the LED 110 is positioned may correspond to the width of the LED 110.

The light guide plate 500, in one embodiment, may have patterns on the first incident surface IS1 where the light emitted from the lamp 120 is incident and the second incident surface IS2 where the light emitted from the LED 110 is incident. The first incident surface IS1 may have the patterns suitable for line light, and the second incident surface IS2 may have the patterns suitable for point light.

The backlight unit 1000, in one embodiment, may include a lamp cover 122 configured to reflect the light emitted from the lamp 120 toward the light guide plate 500. The lamp cover 122 may be shaped such that it surrounds the lamp 120 while not shielding the first incident surface IS1 of the light guide plate 500, for example, may be U-shaped in consideration of light efficiency.

The backlight unit driver 5000, in one embodiment, includes a lamp driving unit 1300 configured to drive the lamp 120, and an LED driving unit 1200 configured to drive the LED 110. The lamp driving unit 1300 may include an inverter 1310 and a transformer 1320 similar to the previous exemplary embodiment described with reference to FIGS. 1 through 5. The LED driving unit 1200 may include a converter 1210 configured to convert an external power, a flash signal generator 1220 configured to turn on and off the LED 110, a modulator 1230 configured to adjust brightness of the LED 110, and an LED driver 1240 configured to stably drive the LED 110.

In one implementation, when the backlight unit assembly starts operating, the lamp 120 is turned on by the lamp driving unit 1300 and the LED is turned on and off by the LED driving unit 1200, so that it is possible to remove image sticking on an LCD panel (not shown). The backlight unit 1000 may include the light guide plate 500, and the lamp 120 and the LED 110 at both sides of the light guide plate 500, and thus a thickness of the backlight unit may be reduced in comparison with a direct light type backlight unit.

As described herein below, a backlight unit assembly, in accordance with still another exemplary embodiment, will be described with reference to the accompanying drawings. Duplicate description, which has been made in the backlight unit assembly of the previous exemplary embodiments, will be omitted or briefly set forth in a below-described exemplary embodiment.

FIG. 8 is a concept view of a backlight unit assembly, in accordance with still another exemplary embodiment. Referring to FIG. 8, the backlight unit assembly of this exemplary embodiment includes a backlight unit 1000 having a light source 100 provided with lamps 120 and LEDs 110, a backlight unit driver 5000 configured to drive the backlight unit 1000, and a controller 1100 configured to control the backlight unit driver 5000. The LED 110 may be provided in plurality, and the plurality of LEDs 110 may be divided into a plurality of LED block regions, which are imaginary block regions with uniform size arranged in a matrix form. An LCD panel (not shown) using the backlight unit assembly of this exemplary embodiment may also be divided into LCD panel block regions with uniform size in a matrix form like the backlight unit assembly that are divided into the LED block regions. The LED block regions and the LCD panel block regions may be defined such that they correspond to each other.

The backlight unit driver 5000, in one embodiment, includes a lamp driving unit 1300 configured to continuously drive the lamp 120, and the LED driving unit 1200 configured to periodically turn on and off the LEDs 110. The controller 1100, which is used to control the backlight unit driver 5000, may include an FPGA 1110 and a time controller 1120. As such, in one implementation, the FPGA 1110 may be configured with a brightness controller 1112 and a dimming controller 1114.

In one embodiment, the brightness controller 1112, which is used to control brightness of the LED 110, analyzes brightness information of an image signal applied from the outside to determine an average brightness on the basis of the analyzed brightness information, and outputs a brightness control signal to the dimming controller 1114. As such, in one implementation, the average brightness means an average brightness level of the image signal to be applied to the LCD panel block region. That is, for example, the average brightness is obtained by adding each brightness level of pixels included in the LCD panel block region and then dividing the added brightness level by number of the pixels in the corresponding LCD panel block region.

In one embodiment, the dimming controller 1114, which is used to control dimming of the LED 110, receives the brightness control signal applied from the brightness controller 1112, and then outputs a dimming control signal to the time controller 1120. The time controller 1120 adds the frame information extracted from the image signal to the dimming control signal applied from the FPGA 1110, thereby applying the dimming control signal containing the frame information to the backlight unit driver 5000. The FPGA 1110 and the time controller 1120 may be mounted on the substrate in the shape of an integrated circuit (IC).

Operation of the backlight unit assembly having the above configuration, in accordance with this exemplary embodiment, is described in detail herein below. In one implementation, when the backlight unit assembly starts operating, the controller 1100 controls the lamp driving unit 1300 so that the lamp 120 is turned on.

Thereafter, the brightness controller 1112 extracts brightness information of the image signal applied to the FPGA 1110 so as to drive the LEDs 110. The brightness information may be obtained by respectively extracting brightness information of the LCD panel block regions. Afterwards, the brightness controller 1112 calculates an average brightness of each LCD panel block region using the extracted brightness information of the image signal. Subsequently, the brightness control signal for the calculated average brightness is applied to the dimming controller 1114, and the dimming controller 1114 then applies the dimming control signal to the time controller 1120 according to the brightness control signal applied thereto. Further, the time controller 1120 adds frame information to the dimming control signal and then outputs the dimming control signal containing the frame information to the flash signal generator 1220.

Next, the flash signal generator 1220 converts a DC power applied from the converter 1210 into a predetermined signal, e.g., a pulse signal, which is periodically turned on and off, such that the LEDs 110 are periodically turned on and off by the dimming control signal containing the frame information. That is, the flash signal generator 1220 converts the DC power supplied from the converter 1210 into a pulse signal such that the brightness of the LED block region is equal to the frame and the average brightness of the LCD panel block region according to the dimming control signal containing the frame information and the average brightness of the LCD panel block region. The pulse signal controls a duty ratio using the frame information contained in the dimming control signal, so that the LEDs 110 are turned off between frames of an image displayed on the LCD panel, and are turned on while frames are displayed. In addition, the pulse signal may have a narrow width suitable for allowing the brightness of the LED block region to correspond to the dimming control signal.

Thereafter, the modulator 1230 modulates the pulse signal applied from the flash signal generator 1220 in PWM manner in order to adjust the brightness of the LED 110 to a predetermined brightness level corresponding to the average brightness. Specifically, the modulator 1230 modulates the pulse signal such that a pulse width is narrowed depending on the magnitude of a modulation signal. Such PWM method changes a duty ratio of a pulse wave that is periodically turned on and off. The pulse signal with the changed duty ratio is then applied to the LED driver 1240, and the pulse signal is stably applied to the LED block region. Accordingly, the LED block region operates such that its brightness is equal to the average brightness of an image displayed on the LCD panel block region and the frame of the image displayed on the LCD panel. Such an operation may be separately and successively performed on each of the corresponding LED block regions according to a display sequence of the LCD panel block regions.

The backlight unit assembly of this exemplary embodiment is adapted to adjust the brightness of the LED 110 in units of a LED block region, which leads to a decrease in power consumption. Further, the brightness of the LED block region is adjusted to correspond to the brightness of the LCD panel block region, which makes it possible to increase contrast ratio.

Herein below, a backlight unit assembly in accordance with even another exemplary embodiment will be described with reference to the accompanying drawings. Duplicate description, which has been made in the backlight unit assembly of the previous exemplary embodiments, will be omitted or briefly set forth in a below-described exemplary embodiment.

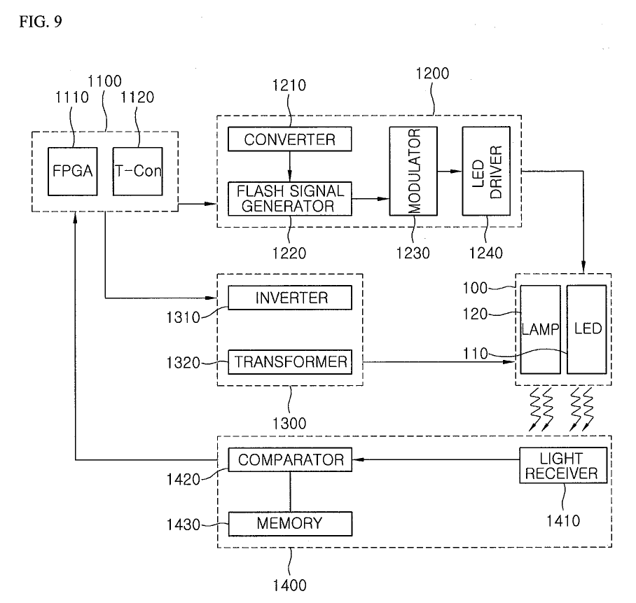

FIG. 9 is a concept view of a backlight unit assembly in accordance with even another exemplary embodiment. Referring to FIG. 9, the backlight unit assembly of this exemplary embodiment includes a backlight unit 1000 having a light source 100 provided with lamps 120 and LEDs 110, a backlight unit driver 5000, and a controller 1100 configured to control the backlight unit driver 5000. Here, the backlight unit driver 5000 includes a lamp driving unit 1300 configured to drive the lamps 120, an LED driving unit 1200 configured to turn on and off the LEDs 110, and a chromaticity coordinate comparator 1400 configured to correct a chromaticity coordinate of the light source 100.

In this exemplary embodiment, the light source 100 emits white light but employs the lamps 120 and the LEDs 110 of which chromaticity coordinates are different from each other. The chromaticity coordinate comparator 1400, which is used to adjust the chromaticity coordinate of the light source by measuring the light emitted from the light source 100, may include a light receiver 1410, a comparator 1420 and a memory 1430. The correction of the chromaticity coordinate may be achieved by adjusting the brightness of each of the lamp 120 or the LED 110.

In one embodiment, the light receiver 1410, which is used to measure a chromaticity coordinate, i.e., wavelength, of the light emitted from the light source 100, may include an optical sensor, e.g., a photodiode, configured to measure current or voltage generated by light emitted from the LED 110. The light receiver 1410 measures the chromaticity coordinate of the light emitted from the light source 100 to apply the measured chromaticity coordinate to the comparator 1420. Alternatively, a signal applied to the comparator 1420 from the light receiver 1410 may be a current value or a voltage value of the LED 110 measured at the light receiver 1410. The memory 1430, which is used to store data for the comparator 1420, may pre-store matching data (i.e., correction value), according to current or voltage data of the LED 110 which are measured depending on the brightness level of the LED 110.

The comparator 1420, in one embodiment, compares the brightness information of the light source 100 (i.e., the current or voltage value of the LED 110) measured by the light receiver 1410 with the matching data stored in the memory 1430, and then applies the related correction value to the controller 1100. When the matching data is applied to the controller 1100, the controller 1100 adjusts the brightness of the lamp 120 or the LED 110 using the matching data, thereby making the chromaticity coordinate of the light source 100 correspond to a reference chromaticity coordinate of the backlight unit assembly.

The backlight unit assembly having the above configuration, in accordance with this exemplary embodiment, operates in similar manner to that in the foregoing exemplary embodiments. That is, the controller 1100 controls the lamp driving unit 1300 so that the lamp 120 is turned on and the LED 110 is periodically turned on and off while the light source is operating.

Thereafter, the light receiver 1410 measure the light emitted from the light source 100, i.e., the lamp 120 and the LED 110, and then applies the measured chromaticity coordinate of the light source 100, i.e., the current or voltage value, to the comparator 1420. The comparator 1420 compares the current or voltage value of the light source 100 with the matching data stored in the memory 1430, and then applies the correction value of the chromaticity coordinate to the controller 1100 using the comparison result. The controller 1100 adjusts the brightness of the lamp 120 or the LED 110, thereby making the chromaticity coordinate of the light source 100 equal to a reference chromaticity coordinate, for example, a chromaticity coordinate in shipment from a factory.

The correction of the chromaticity coordinate of the light source 100 may be achieved by adjusting current applied to the lamp 120 or the LED 110 according to the correction value applied to the controller 1100. For example, it is assumed that the lamp 120 and the LED 110 represent white color with different chromaticity coordinates, e.g., first white color and second white color, respectively. In this case, if the chromaticity coordinate of the light source 100 measured by the light receiver 1410 moves to the first white color, the brightness of the lamp 120 is lowered by reducing the amount of current applied to the lamp 120 and the brightness of the LED 110 is heightened by increasing the amount of current applied to the LED 110, so that the light quantity of the light source 100 is substantially the same as that before adjusting the chromaticity coordinate but the chromaticity coordinate is corrected to the reference chromaticity coordinate.

As described above, the backlight unit assembly, in accordance with this exemplary embodiment, may make the chromaticity coordinate of the light source 100 equal to the reference chromaticity coordinate by adjusting the brightness of each of the lamp 120 and the LED 110 having different chromaticity coordinates. Accordingly, the backlight unit assembly may maintain the chromaticity coordinate corresponding to the reference chromaticity coordinate.

Although the exemplary embodiment of FIG. 9 illustrates that the chromaticity coordinate comparator 1400 having the light receiver is used to automatically correct the chromaticity coordinate of the light source 100, the present disclosure is not limited thereto. That is, the chromaticity coordinate comparator 1400 is not employed but the chromaticity coordinate of the light source 100 is measured using a separate apparatus when fabricating the backlight unit assembly. Therefore, the amount of current applied to the lamp 120 or the LED 110 is adjusted in advance, thus making it possible to equalize chromaticity coordinates of all backlight unit assemblies prepared on a fabrication line. In such a case, the chromaticity coordinates of all backlight unit assemblies prepared on the fabrication line may be equalized even though phosphors of the lamp 120 and the LED 110 are not controlled for adjusting the chromaticity coordinates of the lamp 120 and the LED 110.

Herein below, an LCD in accordance with an exemplary embodiment will be described with reference to the accompanying drawings. Duplicate description, which has been made in the previous exemplary embodiments, will be omitted or briefly set forth in a below-described exemplary embodiment.

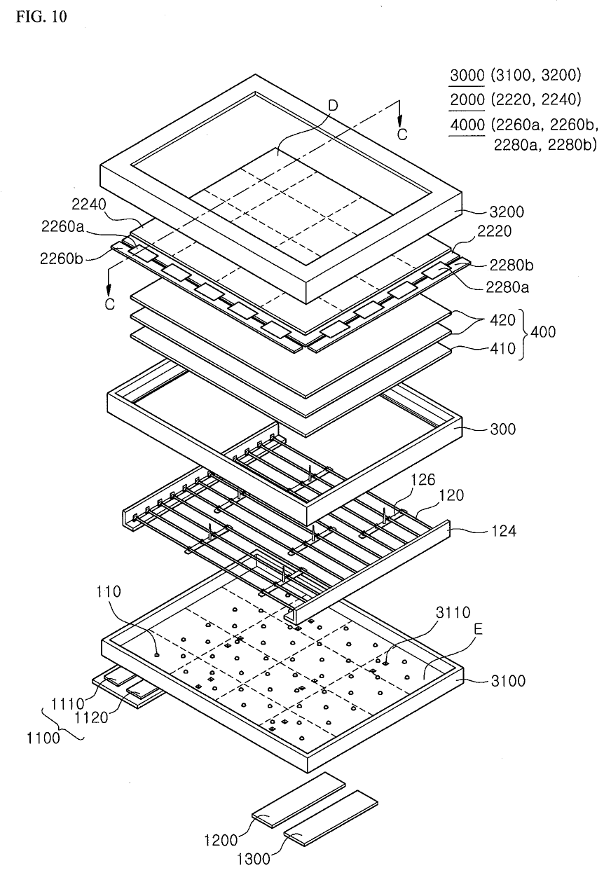

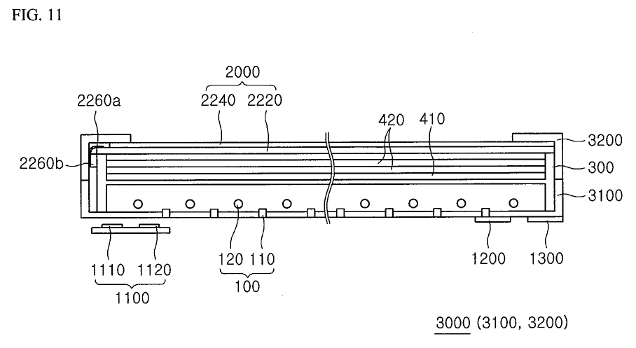

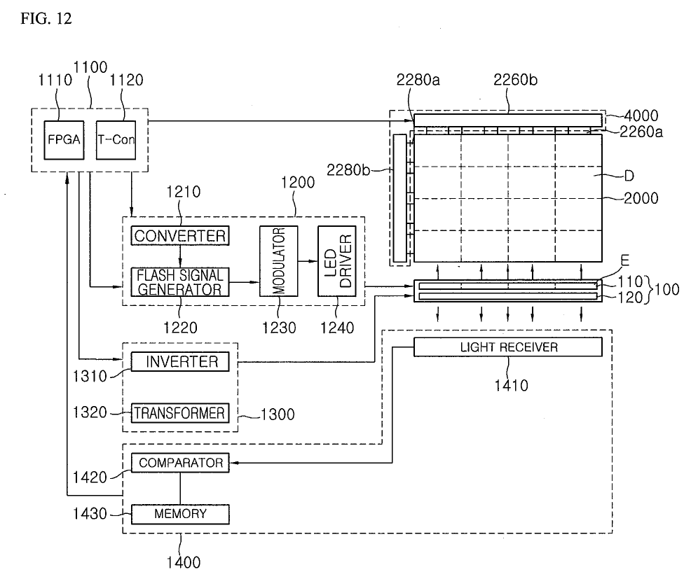

FIG. 10 is a schematic exploded perspective view of an LCD, in accordance with an exemplary embodiment. FIG. 11 is a schematic cross-sectional view taken along line C-C of FIG. 10. FIG. 12 is a concept view of the LCD, in accordance with the exemplary embodiment of FIG. 10.

Referring to FIGS. 10 through 12, the LCD in accordance with this exemplary embodiment includes an LCD panel assembly and a backlight unit assembly. The LCD panel assembly includes an LCD panel 2000 configured to display an image, and an LCD panel driver 4000 configured to drive the LCD panel 2000. The backlight unit assembly includes a backlight unit 1000 configured to supply light to the LCD panel 2000, a backlight unit driver 5000 configured to drive the backlight unit 1000, and a controller 1100 configured to control the LCD panel driver 4000 and the backlight unit driver 5000. The LCD of this exemplary embodiment may include a receiving member 3000 configured to receive and protect the LCD panel assembly and the backlight unit assembly. The LCD panel 2000 may be divided into a plurality of LCD panel block regions D, which are imaginary block regions with uniform size for performing local dimming operation. The backlight unit 1000 may also be divided into a plurality of LED block regions E corresponding to the LCD panel block regions D.

The LCD panel assembly, in one embodiment, includes a thin film transistor (TFT) substrate 2220, a color filter substrate 2240 facing the TFT substrate 2220, an LCD panel 2000 having a liquid crystal layer (not shown) injected between the TFT substrate 2220 and the color filter substrate 2240, and an LCD panel driver 4000 configured to drive the LCD panel 2000. In one implementation, the LCD panel 2000 may include polarizer films (not shown) respectively disposed over the color filter substrate 2240 and under the TFT substrate 2220.

The color filter substrate 2240, in one embodiment, is a substrate having red (R), green (G) and blue (B) pixels exhibiting respective colors, while light passes there through, are formed through thin film process. On the entire surface of the color filter substrate 2240, a common electrode (not shown), i.e., a transparent conductive thin film is formed of a transparent conductive material such as indium tin oxide (ITO) and indium zinc oxide (IZO).

The TFT substrate 2220, in one embodiment, is a transparent glass substrate where TFTs and pixel electrodes are arranged in a matrix form. A data line is connected to a source terminal of the TFT, and a gate line is connected to a gate terminal of the TFT. A pixel electrode (not shown), which is a transparent electrode formed of a transparent conductive material, is connected to a drain terminal of the TFT. When an electrical signal is applied to the data line and the gate line, each of the TFTs are turned on or turned off so that an electrical signal for forming pixels is applied to the drain terminal. The LCD panel driver 4000 may be disposed at one side of the LCD panel 2000 so as to apply an image signal to the LCD panel 2000.

In one embodiment, the LCD panel driver 4000, which is used to drive the LCD panel 2000, includes data-side and gate-side tape carrier packages (TCPs) 2260a and 2280a connected to the TFT substrate 2220, and data-side and gate-side printed circuit boards (PCBs) 2260b and 2280b respectively connected to the data-side and gate-side TCPs 2260a and 2280a. The data-side TCP 2260a and the data-side PCB 2260b may serve as a data driver, and the gate-side TCP 2280a and the gate-side PCB 2280b may serve as a gate driver.

In one embodiment, the backlight unit assembly, which is used to supply light to the LCD panel 2000, includes the backlight unit 1000, the backlight unit driver 5000 and the controller 1100, as mentioned above. The backlight unit 1000 includes a light source 100 configured with lamps 120 and LEDs 110, and an optical sheet 400 configured to improve the quality of light emitted from the light source 100. The backlight unit driver 5000 includes a lamp driving unit 1300 configured to drive the lamps 120, an LED driving unit 1200 configured to turn on and off the LEDs 110, and a chromaticity coordinate comparator 1400 configured to correct a chromaticity of the light source 100.

The controller 1100, in one embodiment, controls the backlight unit driver 5000 to achieve local dimming. In this exemplary embodiment, the light source 100 emits white light but employs the lamps 120 and the LEDs 110 of which chromaticity coordinates are different from each other. The controller 1100 includes an FPGA 1110 and a time controller 1120. The FPGA 1110 codes/decodes an image signal applied from the outside to thereby apply the coded/encoded image signal to the LCD panel driver 4000. The time controller 1120 controls a timing of the image signal applied to source and gate drivers of the LCD panel driver 4000, and applies a dimming control signal containing frame information to the backlight unit driver 5000.

Operation of the LCD having the above configuration, in accordance with this exemplary embodiment, is described herein below. The FPGA 1110 of the controller 1100 receives an external image signal, and codes/decodes the external image signal to apply the coded/decoded image signal to the time controller 1120. The time controller 1120 adjusts the timing of the inputted image signal to apply it to the LCD panel driver 4000. The LCD panel driver 4000 applies the received image signal to the LCD panel 2000 so that the LCD panel 2000 displays an image. The controller 1100 extracts brightness information of an image signal to be applied to the LCD panel driver 4000 to apply the brightness information to a brightness controller 1112 at the same time when the image signal is applied to the LCD panel driver 4000. At the time when the above-described operation starts being performed, the controller 1100 controls the lamp driving unit 1300 to turn on the lamp 120.

Thereafter, the brightness controller 1112 calculates an average brightness of the image signal to be applied to the LCD panel driver 4000 using the extracted brightness information of the image signal, and then applies a brightness control signal to the dimming controller 1114. The dimming controller 1114 modulates a reference voltage signal applied from the converter 1210 using the applied brightness control signal, and outputs the dimming control signal for the average brightness of the image signal to the time controller 1120. The time controller 1120 outputs the dimming control signal with the added frame information to the flash signal generator 1220. Afterwards, the flash signal generator 1220 converts a DC power applied from the converter 1210 into a pulse signal by the applied dimming control signal, and applies the pulse signal to a modulator. The modulator makes a pulse width of the pulse signal narrowed and then applies the pulse signal with narrowed width to the LED driver 1240. Subsequently, the brightness of a corresponding LED block region E is adjusted by the pulse signal applied to the LED driver 1240. The above-described procedure may be cyclically performed.

In one embodiment, the light emitted from the light source 100, i.e., the lamp 120 and the LED 110, is measured by the light receiver 1410, and the light receiver 1410 applies a measured chromaticity coordinate of the light source 100, i.e., current or voltage value, to the comparator 1420. The comparator 1420 applies a correction value of the chromaticity coordinate to the controller 1100 and adjusts brightness of the lamp 120 or the LED, thus making the chromaticity coordinate of the light source 100 correspond to a reference chromaticity coordinate.

In the LCD in accordance with the exemplary embodiment, the lamp 120 is turned on and the LED 110 is periodically turned on and off so that it is possible to remove image sticking on the LCD panel 2000. In one aspect, local dimming operation is performed on the LEDs 110, thereby reducing power consumption and increasing contrast ratio. The LCD of this exemplary embodiment adjusts each brightness of the lamp 120 and the LED 110 having different chromaticity coordinates, and thus the chromaticity coordinate of the light source 100 is controlled so that it is possible to maintain the chromaticity coordinate of the light source 100 to the reference chromaticity coordinate which has been set initially.

Herein below, an LCD using a field sequential driving way, in accordance with another exemplary embodiment, is described with reference to the accompanying drawings. Duplicate description, which has been made in the previous exemplary embodiments, will be omitted or briefly set forth in a below-described exemplary embodiment.

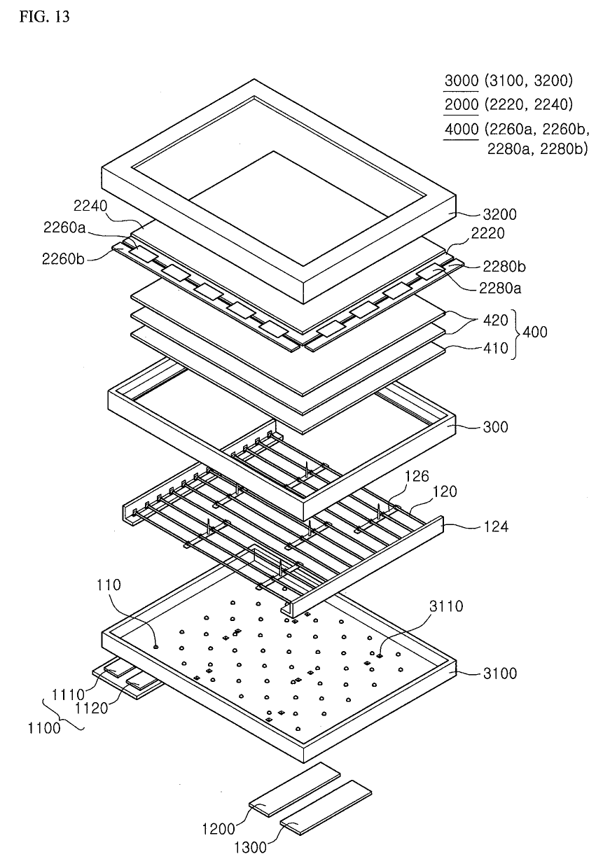

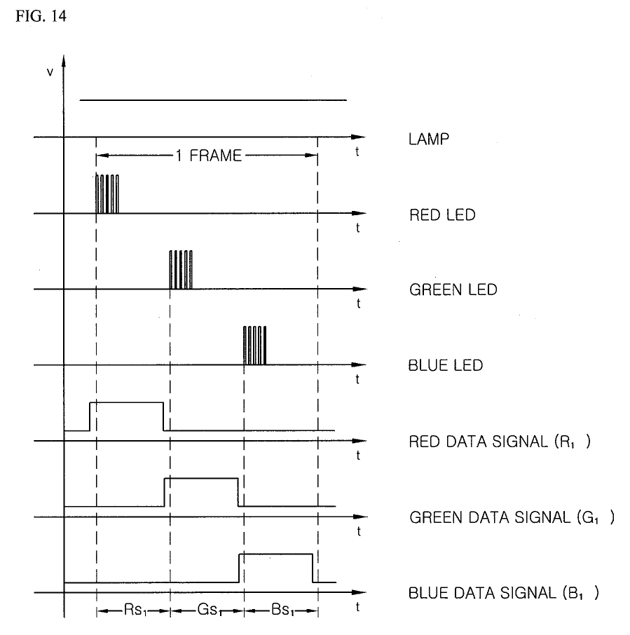

FIG. 13 is a schematic exploded perspective view of an LCD in accordance with another exemplary embodiment. FIG. 14 is a waveform diagram illustrating waveforms of driving signals in the LCD in accordance with the exemplary embodiment of FIG. 13.

Referring to FIG. 13 and FIG. 14, the LCD in accordance with this exemplary embodiment includes an LCD panel assembly and a backlight unit assembly. The LCD panel assembly includes an LCD panel 2000 configured to display an image, and an LCD panel driver 4000 configured to drive the LCD panel 2000. The backlight unit assembly includes a backlight unit 1000 configured to supply light to the LCD panel 2000, a backlight unit driver 5000 configured to drive the backlight unit 1000, and a controller 1100 configured to control the LCD panel driver 4000 and the backlight unit driver 5000.

The LCD of this exemplary embodiment may include a receiving member 3000 configured to receive and protect the LCD panel assembly and the backlight unit assembly. The LCD panel 2000 may be divided into a plurality of LCD panel block regions D, which are imaginary block regions with uniform size for performing local dimming operation. The backlight unit 1000 may also be divided into a plurality of LED block regions E corresponding to the LCD panel block regions D.

The LCD in accordance with this exemplary embodiment divides one image frame into red, green and blue sub frames, and the backlight unit 1000 provides light of color corresponding to each of the sub frames to the LCD panel 2000. In this way, while one image frame is divided into three sub frames, the lamp 120 is turned on and the LED 110 is periodically turned on and off, thereby removing image sticking on the LCD panel 2000. Specifically, in the LCD of this exemplary embodiment, one frame period is divided into a red sub frame period RS1, a green sub frame period GS1 and a blue sub frame period BS1. During the red sub frame period RS1 of the three sub frames, a red data signal R1 is provided from a data driving circuit of the LCD, and a red LED emits light among the red, green and blue LEDs. As a result, red light corresponding to the red data signal R1 is incident on the LCD panel 2000.

Thereafter, during the green sub frame period GS1, a green data signal G1 is provided from the data driving circuit, and a green LED of the backlight unit 1000 emits light. As a result, green light corresponding to the green data signal G1 is incident on the LCD panel 2000. Finally, during the blue sub frame period BS1, a blue data signal B1 is provided from the data driving circuit, and a blue LED emits light. As a further result, blue light corresponding to the blue data signal B1 is incident on the LCD panel 2000. Respective pixels of the LCD panel 2000 generate an image corresponding to red, green and blue light, which are sequentially incident on the LCD panel 2000 from the red, green and blue LEDs. The red, green and blue data signals R1, G1 and B1 are sequentially provided to each of the pixels for every sub frame within one frame period, and the corresponding red, green and blue LEDs of the backlight unit 1000 are sequentially operated to provide red, green and blue light to the LCD panel in sequence. Therefore, the LCD panel 2000 displays an image corresponding to red, green and blue data provided during one frame. The lamp 120 is operated to correct brightness of the LCD panel 2000 but the red, green and blue LEDs are turned on and off during the red, green and blue sub frame periods, respectively.

As described above, the LCD in accordance with this exemplary embodiment operates in field sequential driving way to thereby achieve high definition which is three times higher than that of the related art LCD with the same size. Light efficiency may be improved because color filters are not used. While the LCD of this exemplary embodiment operates in field sequential driving way, the lamp is turned on to correct the brightness of the LCD panel 2000 and the red, green and blue LEDs are turned on and off during the corresponding sub frame periods, which makes it possible to achieve an advantage of the field sequential driving method and also remove image sticking on the LCD panel 2000.

Herein below, an LCD in accordance with still another exemplary embodiment is described herein with reference to the accompanying drawings. Duplicate description, which has been made in the previous exemplary embodiments, will be omitted or briefly set forth in a below-described exemplary embodiment.

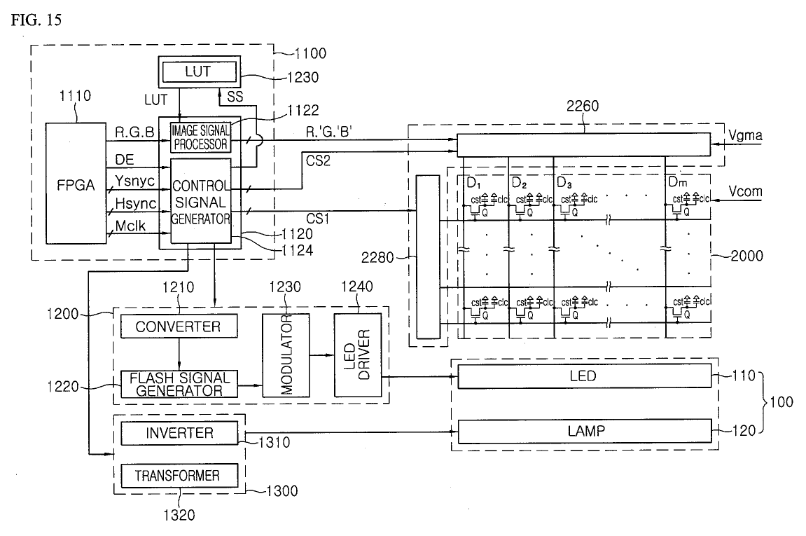

FIG. 15 is a concept view of an LCD, in accordance with still another exemplary embodiment. Referring to FIG. 15, the LCD in accordance with this exemplary embodiment includes an LCD panel assembly and a backlight unit assembly. The LCD panel assembly includes an LCD panel 2000 configured to display an image, and an LCD panel driver 4000 configured to drive the LCD panel 2000. The backlight unit assembly includes a backlight unit 1000 having a light source 100 configured to supply light to the LCD panel 2000, a backlight unit driver 5000 configured to drive the backlight unit 1000, and a controller 1100 configured to control the LCD panel driver 4000 and the backlight unit driver 5000.

The LCD panel 2000, in one embodiment, includes a plurality of unit pixels arranged in a matrix form. The plurality of unit pixels are defined in regions where a plurality of gate lines G1˜Gn extending in a row direction cross a plurality of data lines D1˜Dm extending in a column direction. The unit pixel includes a switching component Q, a liquid crystal capacitor Clc connected to the switching component Q, and a storage capacitor Cst. Although not shown, the LCD panel includes a lower substrate where the switching component Q, the gate line G, the data line D and a pixel electrode are arranged, an upper substrate where a black matrix, a color filter and a common electrode are arranged, and a liquid crystal layer filled between the upper and lower substrates.

In one embodiment, the LCD panel driver 4000 having the gate driver and the data driver are provided at an outer side of the LCD panel 2000. The backlight unit driver 5000 having an FPGA 1110, a timing memory 1230 and a time controller 1120 are provided at an outer side of the backlight unit 1000. Here, the gate driver 2280 and/or the data driver 2260 may be mounted on the lower substrate of the LCD panel 2000. Alternatively, the gate driver 2280 and/or the data driver 2260 may be mounted on a separate PCB, and then they may be electrically connected through a flexible PCB (FPC). The gate driver 2280 and the data driver 2260 of this exemplary embodiment may be formed in the shape of at least one driving chip and then mounted. Although FIG. 15 exemplarily illustrates that the FPGA 1110 and the time controller 1120 may be provided in the backlight unit, the present disclosure is not limited thereto. That is, the FPGA 1110 and the time controller 1120 may be mounted on a PCB, and thus may be electrically connected to the LCD panel 2000 through an FPC.

Timing data for converting an input frame frequency into a predetermined frame frequency are stored in the timing memory 1230. In one aspect, a plurality of sets of correction data of which correction characteristics differ depending on user's position in correcting an image may be stored in the timing memory 1230 besides the timing data. The timing data may be stored in the shape of a look-up table (LUT). The timing memory 1230 may include an electrically erasable and programmable read only memory (EEPROM). In another aspect, the timing memory 1230 may store various kinds of LUTs for generating various control signals besides the above-described LUT. Further, although the timing memory 1230 may be provided at an outer side of the timing controller 1120, it may be built in the time controller 1120 if necessary.

The time controller 1120, in one embodiment, includes an image signal processor 1122 and a control signal generator 1124. The time controller 1120 receives an external image signal and an external control signal applied from an external graphic controller (not shown) through the FPGA 1110 and receives the LUT from the timing memory 1230, thereby generating an internal image signal and an internal control signal which are suitable for operational characteristics of the LCD panel 2000.

The image signal processor 1122, in one embodiment, processes external image data R, G and B to be suitable for the operation conditions of the LCD panel 2000, thereby generating internal image data R′, G′ and B′. Thus, the internal image data R′, G′ and B′ are converted into digital forms, and rearranged to be suitable for pixel arrangement in the LCD panel 2000, which makes it possible to correct the image characteristics.

The control signal generator 1124, in one embodiment, generates a gate control signal CS1 for controlling the gate driver 2280 and a data control signal CS2 for controlling the data driver 2260 using external control signals, i.e., a vertical synchronization signal Vsync, a horizontal synchronization signal Hsync, a main clock MCLK and a data enable signal DE. Further, the control signal generator 1124 transmits the gate control signal CS1 to the gate driver 2280, and transmits the data control signal CS2 to the data driver 2260. The gate control signal CS1 includes a vertical synchronization start signal STV signifying a start of outputting a gate-on voltage Von, a gate clock signal CPV and an output enable signal OE. The data control signal CS2 includes a horizontal synchronization start signal STH signifying a start of transmitting the internal image data R′, G′ and B′, a road signal ROAD for applying a data voltage to a corresponding data line, an inversion signal RVS for inverting a polarity of a gradation voltage for a common voltage, and a data clock signal DCLK.

The control signal generator 1124, in one embodiment, increases a frame rate by twice when correcting the external image data R, G and B, thereby generating the gate control signal CS1 and the data control signal CS2. Accordingly, an operation clock of the vertical synchronization start signal STV, which is a frame discrimination signal, increases from 60 Hz to 120 Hz, and thus frames, which are twice more than before, are displayed during the same period. The control signal generator 1124 generates a select signal SS controlling a select operation of the LUT using the vertical synchronization signal STV, i.e., the frame discrimination signal, thereby transmitting the select signal SS to the timing memory 1230.

The voltage generator 240, in one embodiment, generates and outputs various driving voltages for driving the LCD using external power inputted from an external power supply (not shown). For example, the voltage generator 240 generates a gate-on voltage Von for turning on the switching component Q, and a gate-off voltage Voff for turning off the switching component Q, and outputs the gate-on voltage Von and the gate-off voltage Voff to the gate driver 2280. The voltage generator 240 generates gradation voltages Vgma with a plurality of levels which are applied to pixel electrodes (not shown) and a common voltage Vcom applied to a common electrode (not shown), and outputs the gradation voltages Vgma and the common voltage Vcom to the data driver 2260.

The gate driver 2280, in one embodiment, is controlled according to the gate control signal CS1 from the time controller 1120, and sequentially applies analog signals containing the gate-on voltage Von and the gate-off voltage Voff received from the voltage generator 240 to respective gate lines G1˜Gn as gate signals. The data driver 2260, in one embodiment, is controlled according to the data control signal CS2 from the time controller 1120, and selects a gradation voltage with a specific level corresponding to the internal image data R′, G′ and B′ among the gradation voltages Vgma with the plurality of levels, thereby applying analog signals containing the gradation voltage with the specific level to respective data lines D1˜Dm.

Although it is shown in this exemplary embodiment that the frame frequency increases from 60 Hz to 120 Hz simply, the present disclosure is not limited thereto. That is, a middle frequency frame may be inserted between a first frame with a frame frequency of 60 Hz and a second frame adjacent to the first frame. Here, the middle frequency may be a middle value between frequencies of the first and second frames. As a result, the frame frequency of 60 Hz is changed into the frame frequency of 120 Hz due to the inserted middle frequency frame. Alternatively, the frame frequency may be changed from 60 Hz to 120 Hz by inserting a black frame between the first frame and the second frame adjacent to the first frame.

In accordance with the LCD of this exemplary embodiment, the LCD changes a frame frequency of an image signal from 60 Hz to 120 Hz, and the backlight unit is operated such that the lamp 120 is turned on to correct the brightness of LCD panel 2000 and the red, green and blue LEDs are turned on and off during corresponding sub frame periods. That is, the lamp and the LED differ in driving frequency from each other, and a frame frequency of an image signal changes from 60 Hz to 120 Hz to minimize image sticking, thus making it possible to achieve a sharp image.

In accordance with the exemplary embodiments, as disclosed herein, it is possible to provide a backlight unit assembly having advantages of low power consumption and fast response speed as well as low fabrication cost by configuring a light source with both a lamp and an LED, and an LCD having the backlight unit assembly.

In accordance with the exemplary embodiments, as disclosed herein, the light source is configured with both the lamp and the LED, and the LED is periodically turned on and off by applying a start signal at one time, which makes it possible to provide a backlight unit assembly capable of removing image sticking on an LCD panel and an LCD having the backlight unit assembly.

In accordance with the exemplary embodiments, as disclosed herein, the light source is configured with the lamp and the LED periodically turned on and off, and the LED is locally dimmed so as to correspond an average brightness of the LCD panel. It is possible to provide a backlight unit assembly capable of reducing power consumption and increasing contrast ratio, and an LCD having the backlight unit assembly.

In accordance with the exemplary embodiments, as disclosed herein, it is possible to provide a backlight unit assembly capable of adjusting a chromaticity coordinate of a light source to a reference chromaticity coordinate using a chromaticity coordinate comparator, which may control brightness of the lamp or the LED, and an LCD having the backlight unit assembly.

Although the backlight unit and the liquid crystal display having the same have been described with reference to the specific embodiments, they are not limited thereto. Therefore, it will be readily understood by those skilled in the art that various modifications and changes may be made thereto without departing from the spirit and scope of the present disclosure defined by the appended claims.

What is claimed is:

1. A backlight unit assembly comprising:
a light source having a lamp and a light emitting diode (LED); and
a backlight unit driver having a lamp driving unit configured to drive the lamp and an LED driving unit configured to periodically turn the LED on and off.

2. The backlight unit assembly of claim 1, wherein the lamp and the LED emit respective white colors of which chromaticity coordinates are different from each other.

3. The backlight unit assembly of claim 1, wherein the LED driving unit comprises a flash signal generator configured to generate a flash signal synchronized with a frame of an image signal.

4. The backlight unit assembly of claim 3, further comprising a controller configured to control the backlight unit driver,
wherein the flash signal generator is driven by a start signal applied once from the controller.

5. The backlight unit assembly of claim 4, wherein the LED driving unit comprises:
a modulator configured to modulate an LED driving signal including the flash signal applied from the flash signal generator; and
an LED driver configured to stably apply the LED driving signal applied from the modulator to the LED.

6. The backlight unit assembly of claim 5, wherein the modulator changes a pulse width of a pulse signal generated by the flash signal to be narrowed for adjusting brightness of the LED.

7. The backlight unit assembly of claim 4, wherein the backlight unit driver comprises a chromaticity coordinate comparator configured to adjust a chromaticity coordinate of the light source.

8. The backlight unit assembly of claim 7, wherein the chromaticity coordinate comparator comprises:
a light receiver configured to measure a chromaticity coordinate of the light source; and
a comparator configured to correct the chromaticity coordinate of the light source depending on the chromaticity coordinate of the light source measured by the light receiver.

9. The backlight unit assembly of claim 8, wherein the chromaticity coordinate comparator further comprises a memory configured to store matching data which is a chromaticity coordinate correction value of the light source, and
the comparator compares the measured chromaticity coordinate of the light source with the matching data to apply a chromaticity coordinate correction value to the controller.

10. The backlight unit assembly of claim 4, wherein the controller comprises:
a brightness controller configured to generate a brightness control signal for adjusting brightness of the LED depending on an image signal applied from an external source; and
a dimming controller configured to generate a dimming control signal, which adjusts brightness of the LED depending on the brightness control signal applied from the brightness controller, and to apply the dimming control signal to the flash signal generator.

11. A liquid crystal display (LCD) comprising:
an LCD panel configured to display an image;
an LCD panel driver configured to drive the LCD panel;
a backlight unit configured to provide light to the LCD panel, the backlight unit having a light source having a lamp and an LED; and
a backlight unit driver having a lamp driving unit configured to drive the lamp and an LED driving unit configured to periodically turn the LED on and off.

12. The LCD of claim 11, wherein the LED driving unit comprises a flash signal generator configured to generate a flash signal for turning on and off the LED,
the flash signal generator being driven by a start signal applied once.

13. The LCD of claim 12, wherein the backlight unit driver comprises a chromaticity coordinate comparator configured to adjust a chromaticity coordinate of the light source.

14. The LCD of claim 13, wherein the chromaticity coordinate comparator comprises:
a memory configured to store matching data which is a chromaticity coordinate correction value of the light source;
a light receiver configured to measure the chromaticity coordinate of the light source; and
a comparator configured to compare the measured chromaticity coordinate of the light source with the matching data to apply a chromaticity coordinate correction value to a controller.

15. The LCD of claim 11, wherein the LCD panel comprises at least one or more LCD panel block regions, and the backlight unit comprises an LED block region that corresponds to the LCD panel block region and has at least one or more LEDs,
the LCD further comprising:
a brightness controller configured to determine an average brightness of the LCD panel block regions depending on an image signal applied from an external source to generate a brightness control signal containing the average brightness; and
a dimming controller configured to generate a dimming control signal for separately adjusting brightness of the LED block region according to the brightness control signal applied from the brightness controller, and to apply the dimming control signal to the flash signal generator.

16. A liquid crystal display (LCD) comprising:
an LCD panel configured to display an image;
an LCD panel driver configured to drive the LCD panel;
a backlight unit configured to provide light to the LCD panel, the backlight unit having a light source with a lamp and an LED; and
a backlight unit driver having a lamp driving unit and an LED driving unit that are respectively operated at different frequencies.

17. The LCD of claim 16, further comprising a controller,
the controller comprising:
a field-programmable gate array (FPGA) configured to code/decode an image signal applied from an external source; and
a time controller configured to apply frame information of an image signal applied from the FPGA to a flash signal generator.

18. The LCD of claim 17, wherein the time controller comprises a control signal generator configured to multiplicatively increase a frame rate.

19. The LCD of claim 17, wherein the LED comprises a red LED, a green LED and a blue LED, and
the time controller divides one frame into a plurality of sub frames, and the red, green and blue LEDs respectively emit light in three sub frames of the plurality of sub frames.

20. The LCD of claim 19, wherein the three sub frames include a red data signal, a green data signal and a blue data signal, and
the red, green and blue LEDs emit light corresponding to colors of the three sub frames, respectively.
